(19) United States
(12) Patent Application Publication
(10) Pub. No.: US 2024/0152603 A1
(43) Pub. Date: May 9, 2024

(54) DEVICE FOR EXTRACTING TRACE OF ACT, METHOD FOR EXTRACTING TRACE OF ACT, AND PROGRAM FOR EXTRACTING TRACE OF ACT

(71) Applicant: NIPPON TELEGRAPH AND TELEPHONE CORPORATION, Tokyo (JP)

(72) Inventors: Toshinori USUI, Musashino-shi, Tokyo (JP); Tomonori IKUSE, Musashino-shi, Tokyo (JP); Yuhei KAWAKOYA, Musashino-shi, Tokyo (JP); Makoto IWAMURA, Musashino-shi, Tokyo (JP); Jun MIYOSHI, Musashino-shi, Tokyo (JP)

(73) Assignee: NIPPON TELEGRAPH AND TELEPHONE CORPORATION, Tokyo (JP)

(21) Appl. No.: 18/279,207

(22) PCT Filed: Mar. 16, 2021
(86) PCT No.: PCT/JP2021/010646

§ 371 Date: Aug. 29, 2023

(51) Int. Cl. G06F 21/55; G06F 21/56

(52) U.S. Cl. CPC G06F 21/552; G06F 21/566; G06F 2221/034

(57) ABSTRACT

An activity trace extraction device executes malware to collect an analysis log including a plurality of activity traces of the malware, and executes the malware again in an environment indicating time information different from time information at the time of executing the malware to collect a time change analysis log including a plurality of activity traces of the malware. The activity trace extraction device updates the analysis log by removing, from the analysis log, the activity trace different from the activity trace of the time change analysis log among the plurality of activity traces included in the analysis log based on the analysis log and the time change analysis log. The activity trace extraction device generates trace information of the malware independent of time lapse based on the updated analysis log.

### TECHNICAL FIELD

The present invention relates to an activity trace extraction device, an activity trace extraction method, and an activity trace extraction program useful for detecting malware.

### BACKGROUND ART

As malware gets more sophisticated, malware which is difficult to detect with conventional anti-virus software that detects based on signatures has increased. In addition, detection by the dynamic analysis sandbox that operates transmitted and received files in an isolated environment for analysis and detects malware from the perspective of the malignancy of observed behaviors has also been sensed to be an environment for analysis and avoided by a method such as a method of observing the degree of deviation from a general user environment.

Under such a background, a malware countermeasure technique called Endpoint Detection and Response (EDR) has been used. The EDR is not an environment prepared for analysis but an agent that is installed in a terminal of a user and continuously monitors the behavior of the terminal. Then, the EDR detects malware by using an Indicator Of Compromise (IOC) which is prepared in advance and is so-called a signature of behavior for detecting a trace left when malware acts. Specifically, the EDR matches the IOC with a behavior observed at the terminal, and detects that there is a suspicion of malware infection if they match each other.

Therefore, whether or not malware can be detected by the EDR depends on whether IOCs useful for detecting certain malware are held. On the other hand, in a case where IOCs match not only malware but also activity traces of legitimate software, there is a problem that erroneous detection occurs. Accordingly, it is necessary to selectively extract traces useful for detection to form IOCs rather than merely randomly increasing the number of IOCs out of malware traces.

In addition, it is necessary to selectively extract traces useful for detection to form IOCs also from the viewpoint of the number of IOCs that the EDR can perform matching at a time. That is, since the EDR generally takes more time for matching as it has more IOCs, it is desirable to have a combination of IOCs which enables detection of more types of malware with a smaller number of IOCs. In this case, in a case where an IOC is generated from an activity trace not useful for detection, it leads to unnecessary time for matching.

Currently, new malware is created every day, and IOCs corresponding to them also continue to change. Therefore, in order to continuously cope with them, it is necessary to automatically analyze malware, extract activity traces, and generate IOCs. IOCs are generated based on activity traces obtained by analyzing malware. Typically, traces obtained by executing malware while monitoring its behavior are collected, and the traces are normalized or a combination of traces suitable for detection is selected to obtain IOCs.

Due to the above, a technique for selectively and automatically extracting an activity trace useful for detecting malware is desired. For example, there are Non Patent Literature 1 and Non Patent Literature 2 as a technique for extracting an activity trace.

Non Patent Literature 1 proposes a method of extracting trace patterns repeatedly observed repeatedly observed among multiple pieces of malware and using the patterns as IOCs.

In addition, Non Patent Literature 2 proposes a method of automatically generating an IOC that is easy for humans to understand by extracting a set of traces co-occurring between pieces of malware of the same family and preventing an increase in the complexity of the IOC by a set optimization method.

According to the methods of Non Patent Literatures 1 and 2 and the like, it is possible to automatically extract an IOC that can contribute to malware detection from an execution trace log. Here, the execution trace is to track an execution status of a program by sequentially recording behaviors from various viewpoints at the time of execution. In addition, a program having a function of monitoring and recording behaviors in order to realize this is called a tracer. For example, a record in which executed application programming interfaces (APIs) are sequentially recorded is referred to as an API trace, and a program for realizing the API trace is referred to as an API tracer.

### CITATION LIST

### Non Patent Literature

Non Patent Literature 1: Christian Doll et al. “Automated Pattern Inference Based on Repeatedly Observed Malware Artifacts.” Proceedings of the 14th International Conference on Availability, Reliability and Security. 2019.

Non Patent Literature 2: Yuma Kurogome et al. “EIGER: Automated IOC Generation for Accurate and Interpretable Endpoint Malware Detection.” Proceedings of the 35th Annual Computer Security Applications Conference. 2019.

### SUMMARY OF INVENTION

### Technical Problem

However, in the above-described conventional techniques (Non Patent Literatures 1 and 2), there is a problem that time dependency and environment dependency of activity traces are not taken into consideration, and thus activity traces not effective for detection may also be formed into IOCs.

Here, the time dependency of an activity trace is a characteristic that an activity trace changes depending on temporal information at the time of execution of malware. The temporal information includes time, time having elapsed since startup, and the like. Time-dependent activity traces are not available as IOCs since temporal information in an analysis environment in which the traces are collected is different from temporal information in an environment actually attacked.

Meanwhile, the time dependency of an activity trace is a characteristic that an activity trace changes depending on environmental information at the time of execution of malware. The environmental information includes various setting information of a system or a device. A conceivable example is a case in which an activity trace is changed based on the UUID of a system disk. Time-dependent activity traces are also not available as IOCs since environmental information in an analysis environment in which the traces are collected is different from environmental information in an environment actually attacked.

In other words, to determine whether or not a collected activity trace has time dependency or environment dependency is important in selectively extracting an activity trace effective for detection and generating an IOC.

The present invention has been made in view of the above, and an object thereof is to provide an activity trace extraction device, an activity trace extraction method, and an activity trace extraction program capable of selectively extracting an activity trace effective for detection and generating an effective IOC.

### Solution to Problem

In order to solve the above problems and achieve the object, an activity trace extraction device according to the present invention includes: a collection unit that is configured to execute malware to collect an analysis log including a plurality of activity traces of the malware, and execute the malware again in an environment indicating time information different from time information at the time of executing the malware to collect a time change analysis log including a plurality of activity traces of the malware; an update unit that is configured to update the analysis log by removing, from the analysis log, the activity trace different from the activity trace of the time change analysis log among the plurality of activity traces included in the analysis log based on the analysis log and the time change analysis log; and a generation unit that is configured to generate trace information of the malware independent of time lapse based on the updated analysis log.

### Advantageous Effects of Invention

By detecting the time dependency and environment dependency of an activity trace, it is possible to selectively extract an activity trace effective for detection and generate an effective IOC.

### BRIEF DESCRIPTION OF DRAWINGS

FIG. 1 is a diagram illustrating processing of an activity trace extraction device according to this example.

FIG. 2 is a functional block diagram illustrating a configuration of the activity trace extraction device according to this example.

FIG. 3 is a diagram illustrating an example of a data structure of a history DB.

FIG. 4 is a diagram illustrating an example of an analysis log and an activity trace.

FIG. 5 is a diagram illustrating an example of time-dependent activity traces.

FIG. 6 is a diagram illustrating an example of environment-dependent activity traces.

FIG. 7 is a diagram illustrating an example of comparison of analysis logs.

FIG. 8 is a flowchart illustrating a processing procedure of the activity trace extraction device according to this example.

FIG. 9 is a flowchart illustrating a processing procedure for identifying a dependent activity trace by comparing analysis logs.

FIG. 10 is a flowchart illustrating a processing procedure for changing environment information of a system using an API hook.

FIG. 11 is a flowchart illustrating a processing procedure for changing environment information of the system by changing an analysis environment.

FIG. 12 is a diagram illustrating an example of a computer that executes an activity trace extraction program.

### DESCRIPTION OF EMBODIMENTS

Hereinafter, an example of an activity trace extraction device, an activity trace extraction method, and an activity trace extraction program disclosed in the present application will be described in detail with reference to the drawings. Note that the present invention is not limited to this example.

### EXAMPLE

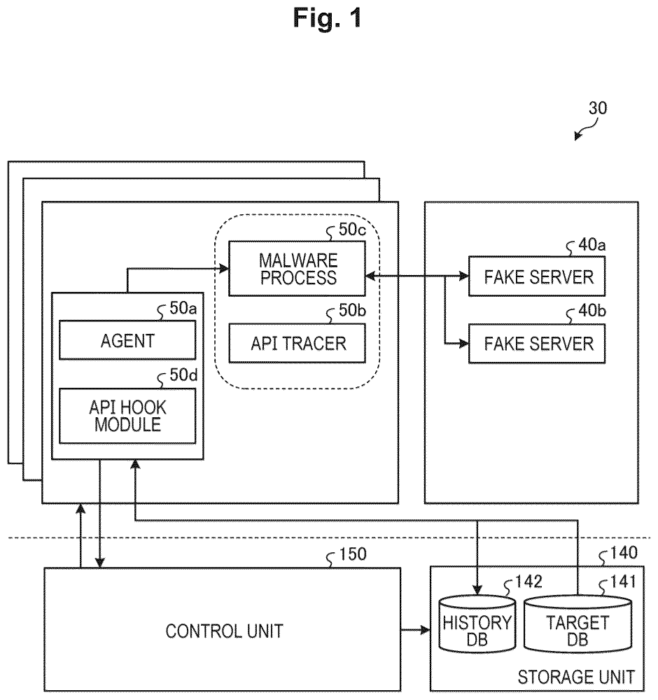

FIG. 1 is a diagram illustrating processing of an activity trace extraction device according to this example. As illustrated in FIG. 1, the activity trace extraction device includes a storage unit 140 and a control unit 150.

The storage unit 140 is implemented by a semiconductor memory element such as a random access memory (RAM) or a flash memory, or a storage device such as a hard disk or an optical disk. The storage unit 140 includes a target data base (DB) 141 and a history DB 142.

The target DB 141 holds data of multiple pieces of malware used to extract an activity trace. The history DB 142 holds information of an analysis log obtained when malware is executed.

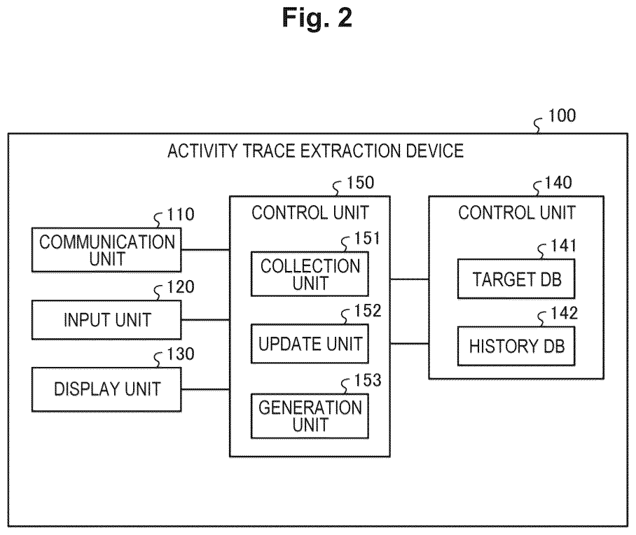

The control unit 150 is implemented using a central processing unit (CPU) or the like. The control unit 150 executes an agent 50a, an API tracer 50b, and an API hook module 50d in a virtual environment 30. The agent 50a reads malware from the target DB 141, and a malware process 50c is executed. The control unit 150 executes a fake server 40a and a fake server 40b in the virtual environment 30. In FIG. 1, for convenience of description, the virtual environment 30 is illustrated outside the control unit 150, but the virtual environment 30 is executed inside the control unit 150. Further, as described with reference to FIG. 2, the control unit 150 includes a collection unit 151, an update unit 152, and a generation unit 153. For example, processing executed in the virtual environment 30 is executed by the collection unit 151.

For example, the fake server 40a is a fake server that responds as a domain name system (DNS) server when accepting an access from the malware process 50c. The fake server 40b is a fake server that responds as a hyper text transfer protocol (HTTP) server when accepting an access from the malware process 50c. The fake servers 40a and 40b may be fake servers that execute processing of other servers. In addition, an appropriately prepared actual environment may be used without using a fake server.

The control unit 150 executes processing of extracting an activity trace, processing of extracting time dependency, processing of extracting environment dependency, and processing of generating an IOC.

The “processing of extracting an activity trace” will be described. The control unit 150 executes the malware process 50c using the API tracer 50b, collects an activity trace from an analysis log traced by the API tracer 50b, and registers information on the activity trace in the history DB 142.

The control unit 150 traces a system API when a target for which an IOC is to be generated is executable malware, and traces a script API when the target is script malware. The malware process 50c accesses the fake servers 40a and 40b and the like and executes various types of processing (other network communication, file operation, registry operation, process generation, and the like).

The API tracer 50b monitors the operation of the malware process 50c and acquires an analysis log. The API tracer 50b outputs the acquired analysis log to the agent 50a. For example, on the basis of information acquired by the API tracer 50b, the generation unit 153 to be described later defines in advance from which activity trace (e.g., network communication, file operation, registry operation, process generation, and the like) an IOC is to be generated and an API having a function corresponding to this activity trace, and searches the analysis log for the API and arguments to collect the activity trace of the malware process 50c.

In general, in order for the malware process 50c to achieve malicious behavior, it is necessary to invoke an API to interact with a system (e.g., an operating system, each device connected to the activity trace extraction device, or another external device connected via a network). Since the behavior of leaving an activity trace is also not an exception, the generation unit 153 can collect the activity trace of the target malware process 50c without missing it by monitoring an API using the API tracer 50b.

An environment for extracting the above activity trace is implemented by API hooks for detection of time dependency and environment dependency to be described below. For example, the API hook module 50d has a function of setting an API hook and changing an execution result of the API.

The “processing of extracting time dependency” will be described. The control unit 150 compares analysis logs traced by the API tracer 50b in two time-varying first and second environments, and thus identifies a time-dependent activity trace among multiple activity traces included in the analysis logs.

A difference between the first environment and the second environment is that time information of an environment in which the malware process 50c executes processing is different. For example, at first time, the control unit 150 executes the malware process 50c, acquires multiple activity traces collected by the API tracer 50b as a first analysis log in the first environment, and registers the activity traces in the history DB 142.

At second time after a lapse of a predetermined time period from the first time, the control unit 150 executes the malware process 50c, acquires multiple activity traces collected by the API tracer 50b as a second analysis log in the second environment, and registers the activity traces in the history DB 142.

The control unit 150 compares the first analysis log and the second analysis log collected in the two execution environments, and when there is a difference between activity traces, detects the different activity traces as time-dependent activity traces.

The control unit 150 can collect the second analysis log in the second environment by creating a snapshot of the first environment (holding information at the first time) immediately before executing and acquiring the malware process 50c in the first environment and executing the malware process 50c again when a certain time period elapses from the snapshot.

The control unit 150 may implement a difference between the time information of the first environment and the time information of the second environment by hooking an API for acquiring the time and the time having elapsed after activation using an API hook and making a change so as to return a value different from an actual value.

The “processing of extracting environment dependency” will be described. The control unit 150 compares analysis logs traced by the API tracer 50b in two first and third environments different in a system, a device, or the like allocated to the malware process 50c, and thus identifies an environment-dependent activity trace among multiple activity traces included in the analysis logs.

A difference between the first environment and the third environment is that information on a system or a device of an environment in which the malware process 50c executes processing is different.

The control unit 150 identifies whether or not there is a call for an API for acquiring information of a system or a device described in a list of APIs (APIs for acquiring information of a system or a device) in the first analysis log. In a case where there is no call for an API for acquiring information of a system or a device in the first analysis log, the control unit 150 determines that there is no environment-dependent activity trace in the first analysis log.

On the other hand, in a case where there is a call for an API for acquiring information of a system or a device in the first analysis log, the control unit 150 determines that there may be an environment-dependent activity trace among the activity traces included in the first analysis log.

In this case, in the first environment, the control unit 150 allocates, to the virtual environment 30, a (different) system or device that substitutes for information acquired by an API (API for acquiring information on a system or a device) called by the malware process 50c, and thus executes the malware process 50c in the third environment. The control unit 150 registers a third analysis log traced by the API tracer 50b in the history DB 142 in the third environment.

The control unit 150 may implement a difference between the information of the system or the device in the first environment and the information of the system or the device in the third environment by hooking an API for acquiring the information of the system or the device using an API hook and making a change so as to return a value different from an actual value. Alternatively, the control unit 150 may implement a difference in information unique to an application between the first environment and the third environment by hooking an API for acquiring information unique to specific application software (hereinafter, the application) (e.g., setting information of a specific application), and further changing the API so as to return a value different from an actual value.

The control unit 150 compares the first analysis log and the third analysis log collected in the two execution environments, and when there is a difference between activity traces, detects the different activity traces as environment-dependent activity traces.

For example, in a case where the malware process 50c calls an API for acquiring information on the UUID of a disk (information on the system), the control unit 150 changes the information on the UUID of the disk held by the operating system through the agent 50a. In addition, in a case where the malware process calls an API for acquiring information on the number of cores of the CPU (information on the device), the control unit 150 changes the number of cores allocated to a virtual machine. The control unit 150 may implement the difference by hooking an API for acquiring the information of the system or the device using an API hook and making a change so as to return a value different from an actual value.

The “processing of generating an IOC” will be described. The control unit 150 updates the first analysis log by removing the time-dependent activity trace and the environment-dependent activity trace from the activity traces of the first analysis log stored in the history DB 142. The control unit 150 generates an IOC based on the updated first analysis log. The control unit 150 may generate an IOC using the techniques described in Non Patent Literatures 1 and 2.

Next, an example of a configuration of the activity trace extraction device that executes the processing described in FIG. 1 will be described. FIG. 2 is a functional block diagram illustrating a configuration of the activity trace extraction device according to this example. As illustrated in FIG. 2, this activity trace extraction device 100 includes a communication unit 110, an input unit 120, a display unit 130, the storage unit 140, and the control unit 150.

The communication unit 110 is a communication interface that transmits and receives various types of information to and from an external device connected via a network or the like. The communication unit 110 is implemented by a network interface card (NIC) or the like, and performs communication between the external device and the control unit 150 via a telecommunication line such as a local area network (LAN) or the Internet.

The input unit 120 is an input interface that receives various operations from an operator of the activity trace extraction device 100. For example, the input unit is constituted of an input device such as a keyboard and a mouse.

The display unit 130 is an output device that outputs information acquired from the control unit 150, and is implemented by a display device such as a liquid crystal display, a printing device such as a printer, or the like.

The storage unit 140 includes the target DB 141 and the history DB 142. The storage unit 140 corresponds to the storage unit 140 described in FIG. 1. The target DB 141 holds data of multiple pieces of malware used to extract an activity trace. The malware may be executable malware or script malware.

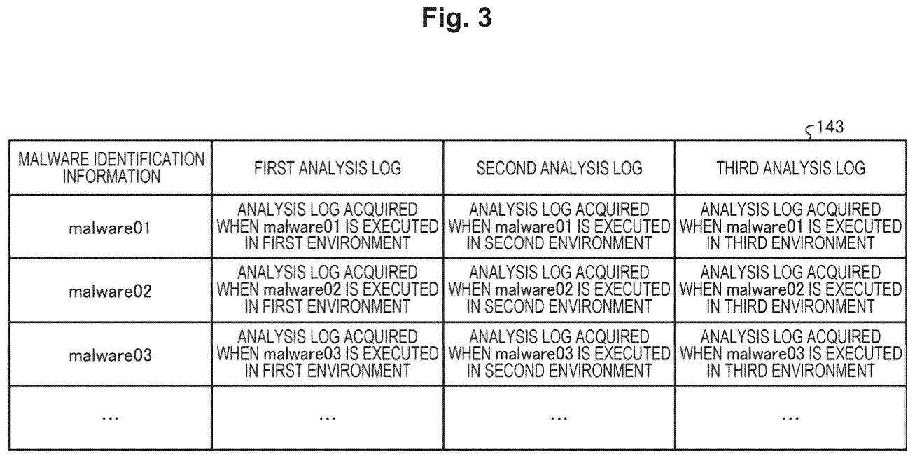

The history DB 142 holds information of the analysis log executed in each environment. FIG. 3 is a diagram illustrating an example of a data structure of the history DB. As illustrated in FIG. 3, the history DB 143 holds malware identification information, the first analysis log, the second analysis log, and the third analysis log.

The malware identification information is information for identifying malware. The first analysis log is an analysis log collected by executing corresponding malware in the first environment. The second analysis log is an analysis log collected by executing corresponding malware in the second environment. The third analysis log is an analysis log collected by executing corresponding malware in the third environment.

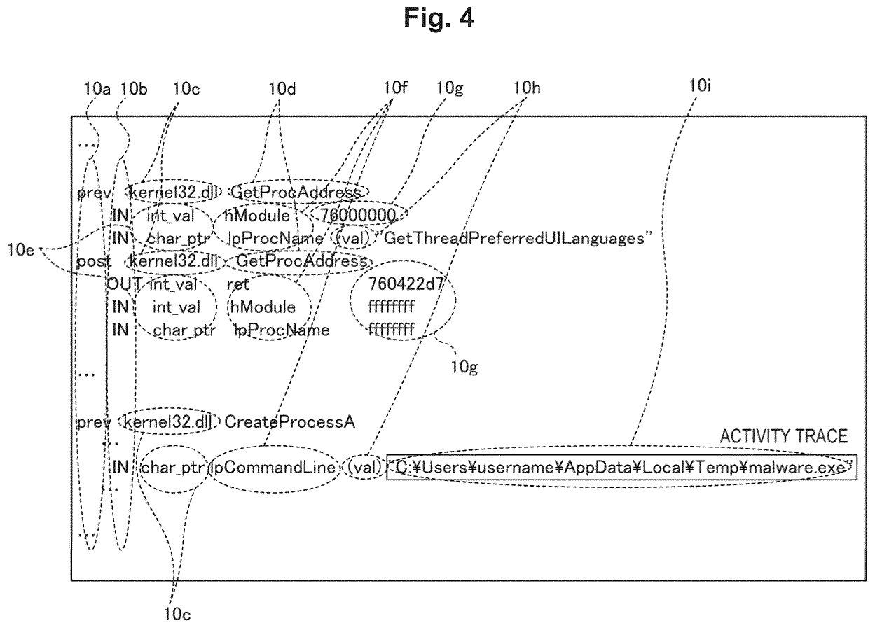

FIG. 4 is a diagram illustrating an example of an analysis log and an activity trace. In FIG. 4, “prev” included in an area 10a indicates before execution of an API, and “post” indicates after execution of the API. “IN” included in an area 10b indicates input, and “OUT” indicates output. A character string included in an area 10c indicates a DLL name. A character string included in an area 10d indicates an API name. A character string included in an area 10e indicates a type. A character string included in an area 10f corresponds to a variable name. A character string and a numerical value included in an area 10g correspond to arguments. “val” included in an area 10h indicates that a value obtained by dereferencing a pointer is recorded. An area 10i includes an activity trace. In the example illustrated in FIG. 4, it is indicated that a lpCommandLine argument of CreateProcess is an activity trace related to a process in this malware.

The control unit 150 executes processing of extracting an activity trace, processing of extracting time dependency, processing of extracting environment dependency, and processing of generating an IOC. The control unit 150 corresponds to the control unit 150 described in FIG. 1. For example, the control unit 150 includes the collection unit 151, the update unit 152, and the generation unit 153.

The collection unit 151 reads malware from the target DB 141 and executes malware in each environment to collect an analysis log in each environment.

For example, the collection unit 151 executes the agent 50a, the API tracer 50b, and the fake servers 40a and 40b in the virtual environment 30 described in FIG. 1. The collection unit 151 reads malware from the target DB 141 and executes the malware to operate the malware process 50c. The collection unit 151 executes the malware process 50c and collects the analysis log traced by the API tracer 50b.

The collection unit 151 collects the first analysis log by executing the malware process 50c in the first environment. When collecting the first analysis log, the collection unit 151 acquires, using an API hook or the like, information (snapshot) on the first time when the malware process 50c is executed.

The collection unit 151 collects the second analysis log by executing the malware process 50c again in the second environment after a lapse of a certain time from the first time.

In a case where there is a call for an API for acquiring information of a system or a device in the first analysis log as a result of scanning the first analysis log, the collection unit 151 determines that there is an environment-dependent activity trace among the activity traces included in the first analysis log.

The collection unit 151 executes the malware process 50c in the third environment by changing system information to one different from the system information in the first environment. The collection unit 151 collects the third analysis log traced by the API tracer 50b in the third environment.

Here, in a case where there is no call for an API for acquiring information of a system or a device in the first analysis log, the collection unit 151 determines that there is no environment-dependent activity trace in the first analysis log.

The collection unit 151 registers the collected first analysis log, second analysis log, and third analysis log in the history DB 142 in association with the malware identification information.

The collection unit 151 also executes the above processing for other malware registered in the target DB 141, collects the first analysis log, the second analysis log, and the third analysis log, and iterates the processing of registering the first analysis log, the second analysis log, and the third analysis log in the history DB 142.

The update unit 152 is a processing unit that updates the first analysis log by removing a time-dependent activity trace and an environment-dependent activity trace from the first analysis log. For example, the update unit 152 removes an activity trace that does not match the activity trace of the second analysis log among the activity traces of the first analysis log as a time-dependent activity trace.

The update unit 152 removes an activity trace that does not match the activity trace of the third analysis log among the activity traces of the first analysis log as an environment-dependent activity trace.

The update unit 152 iterates the above processing for each first analysis log registered in the history DB 142.

The generation unit 153 generates an IOC based on the first analysis log updated by the update unit 152. The generation unit 153 may generate an IOC using the techniques described in Non Patent Literatures 1 and 2. The generation unit 153 may store the generated IOC in the storage unit 140 or may notify an external device of the IOC.

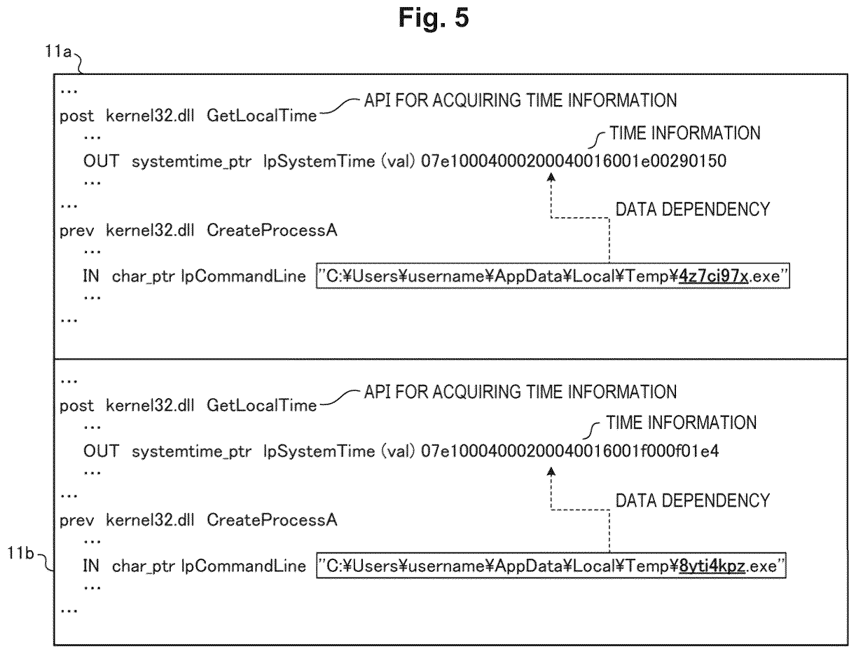

FIG. 5 is a diagram illustrating an example of time-dependent activity traces. In FIG. 5, “GetLocalTime” is a system API for acquiring time information, and indicates time information on the system time. It is assumed that there is data dependency between “lpSystemTime” that is an output value of “GetLocalTime” and stores the system time and the activity trace of a process name. That is, it is assumed that the process name is determined on the basis of the value of “lpSystemTime”.

For example, an analysis log 11a corresponds to the first analysis log, and an analysis log 11b corresponds to the second analysis log. When there is a difference between the system time of the analysis log 11a and the system time of the analysis log 11b, the activity traces are also different accordingly. This is time dependency.

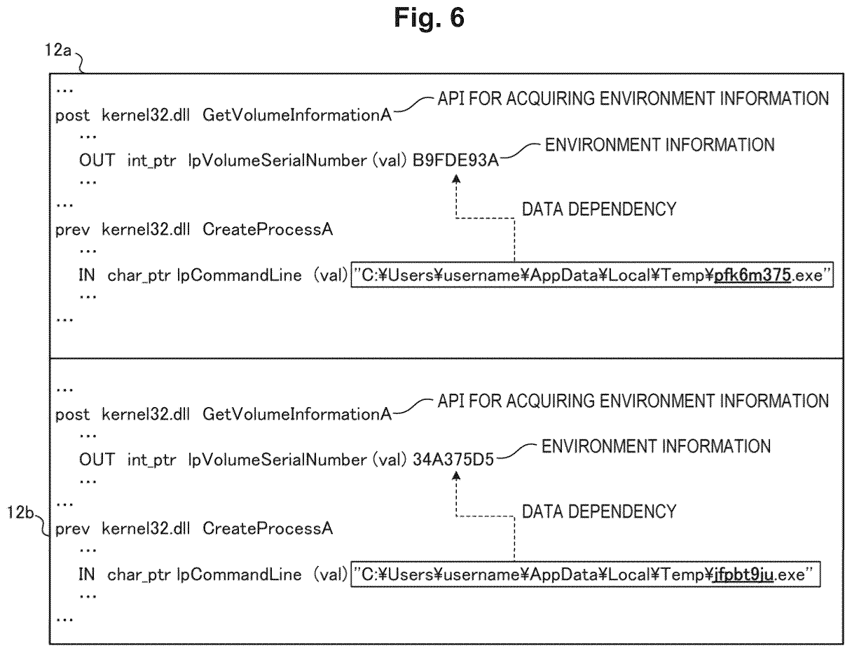

FIG. 6 is a diagram illustrating an example of environment-dependent activity traces. In FIG. 6, “GetVolumeInformationA” is a system API, and acquires environment information on a volume. It is assumed that there is data dependency between lpVolumeSerialNumber that is an output value of “GetVolumeInformationA” and stores the serial number of the volume and the activity trace of a process name. That is, it is assumed that the process name is determined on the basis of the value of the serial number of the volume.

For example, an analysis log 12a corresponds to the first analysis log, and an analysis log 12b corresponds to the third analysis log. When there is a difference between the serial number of the analysis log 12a and the serial number of the analysis log 11b, the activity traces are also different accordingly. This is environment dependency.

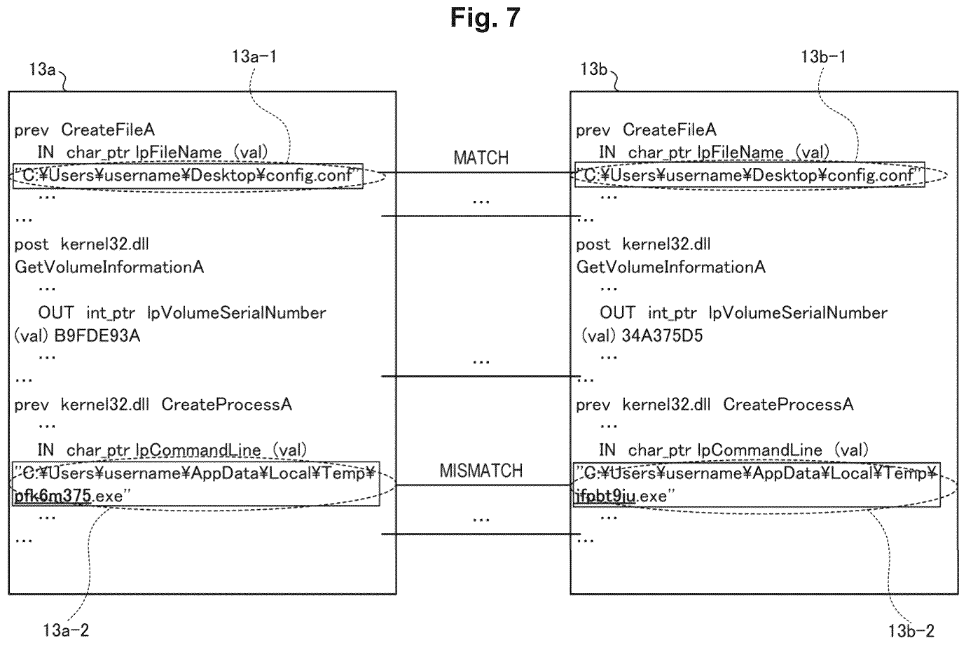

FIG. 7 is a diagram illustrating an example of comparison of analysis logs. FIG. 7 illustrates an analysis log 13a and an analysis log 13b. The update unit 152 associates API calls of the two analysis logs 13a and 13b with each other. This association is performed by, for example, extraction of the longest common part, but is not limited to this. The update unit 152 compares the activity traces of the corresponding API calls with each other, and identifies whether or not they match each other. In the example illustrated in FIG. 7, a character string in an area 13a-1 matches a character string in an area 13b-1, but a character string in an area 13a-2 does not match a character string in an area 13b-2. For example, the update unit 152 removes the character string in the area 13a-2 and the character string in the area 13b-2 which do not match each other.

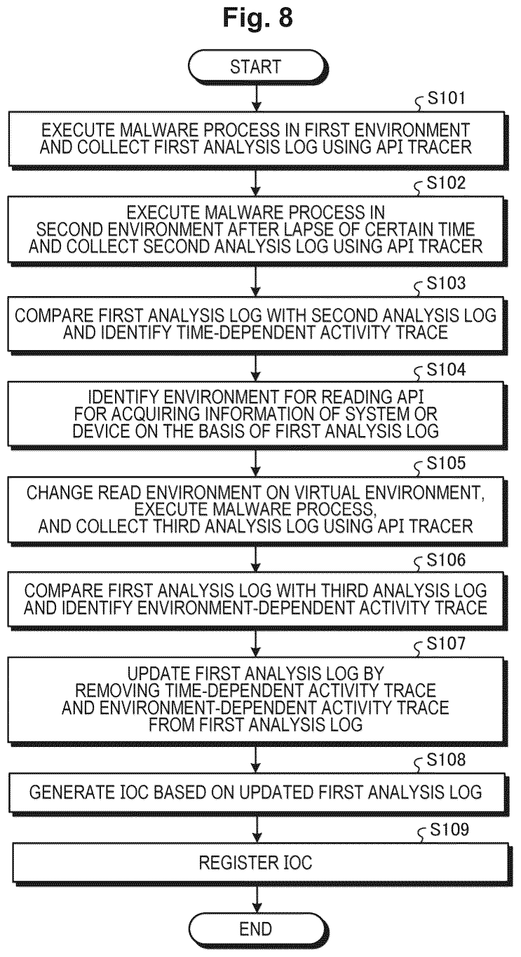

Next, an example of a processing procedure of the activity trace extraction device 100 according to this example will be described. FIG. 8 is a flowchart illustrating a processing procedure of the activity trace extraction device according to this example. The collection unit 151 of the activity trace extraction device 100 executes the malware process 50c in the first environment and collects the first analysis log using the API tracer 50b (step S101).

After a lapse of a certain time, the collection unit 151 executes the malware process 50c in the second environment and collects the second analysis log using the API tracer 50b (step S102). The update unit 152 of the activity trace extraction device 100 compares the first analysis log with the second analysis log, and identifies a time-dependent activity trace (step S103).

The collection unit 151 identifies an environment for reading an API for acquiring information of a system or a device on the basis of the first analysis log (step 3104). The collection unit 151 changes the read environment on the virtual environment, executes the malware process 50c, and collects the third analysis log using the API tracer 50b (step S105).

The update unit 152 compares the first analysis log with the third analysis log, and identifies an environment-dependent activity trace (step S106). The update unit 152 updates the first analysis log by removing the time-dependent activity trace and the environment-dependent activity trace from the first analysis log (step S107).

The generation unit 153 generates an IOC based on the updated first analysis log (step S108). The generation unit 153 registers the IOC in the storage unit 140 (step S109).

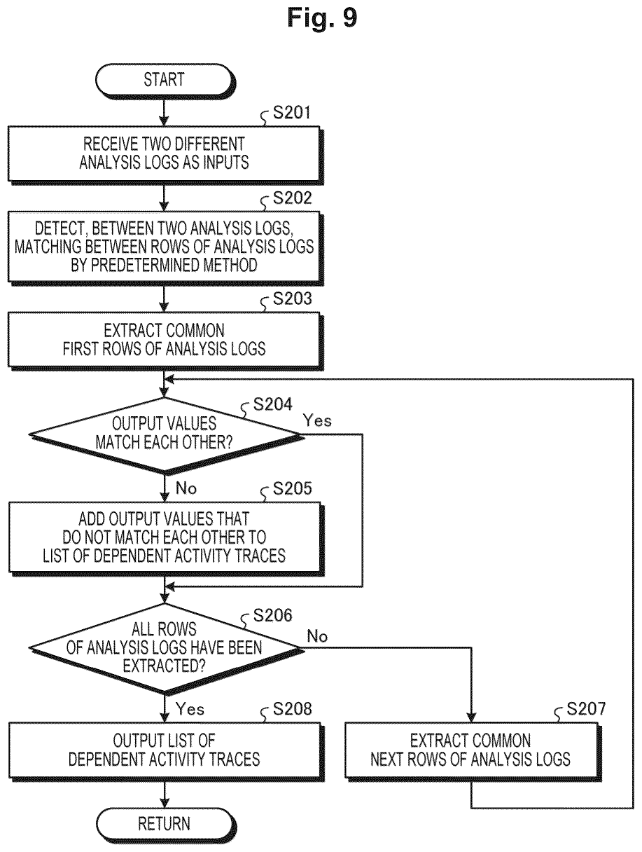

FIG. 9 is a flowchart illustrating a processing procedure for identifying a dependent activity trace by comparing analysis logs. The processing in FIG. 9 corresponds to the processing in steps S103 and S106 of FIG. 8.

As illustrated in FIG. 9, the control unit 150 of the information processing device 100 receives two different analysis logs as inputs (step S201). The control unit 150 detects, between the two analysis logs, matching between rows of the analysis logs by a predetermined method (step S202). For example, the control unit 150 executes the processing of step S202 by extracting the longest common part or the like.

The control unit 150 extracts common first rows of the analysis logs (step S203). In a case where output values match each other (Step S204, Yes), the control unit 150 proceeds to step S206. On the other hand, in a case where the output values do not match each other (Step S204, No), the control unit 150 adds the output values that do not match each other to a list of dependent activity trajectories (step S205).

In a case where all the rows of the analysis logs have not been extracted (Step S206, No), the control unit 150 extracts common next rows of the analysis logs (step S207) and proceeds to step S204. On the other hand, in a case where all the rows of the analysis logs have been extracted (Step S206, Yes), the control unit 150 outputs a list of dependent activity traces (step S208).

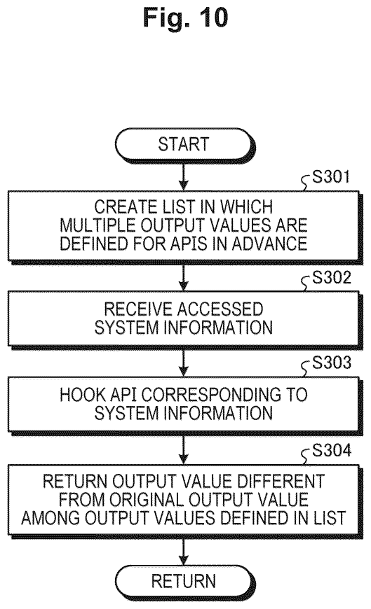

FIG. 10 is a flowchart illustrating a processing procedure for changing environment information of a system using an API hook. As illustrated in FIG. 10, the control unit 150 of the information processing device 100 creates a list in which multiple output values are defined for APIs in advance (step S301). The collection unit 151 receives accessed system information (step S302).

The control unit 150 hooks an API corresponding to the system information (step S303). The control unit 150 returns an output value different from the original output value among the output values defined in the list (step S304).

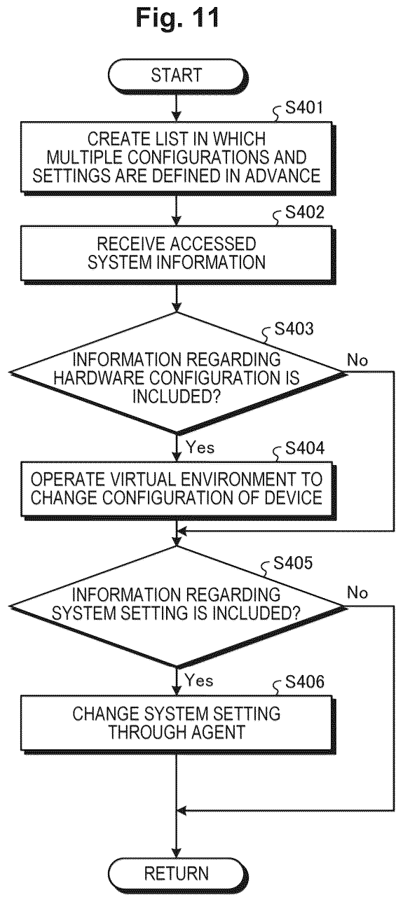

FIG. 11 is a flowchart illustrating a processing procedure for changing environment information of a system by changing an analysis environment. As illustrated in FIG. 11, the control unit 150 creates a list in which multiple configurations and settings are defined in advance (step S401). The control unit 150 receives accessed system information (step S402). In a case where no information regarding the hardware configuration is included in the system information (Step S403, No), the control unit 150 proceeds to step S405.

In a case where information regarding the hardware configuration is included in the system information (Step S403, Yes), the control unit 150 operates the virtual environment 30 to change the configuration of the device (step S404).

In a case where no information regarding the system setting is included in the system information (Step S405, No), the control unit 150 terminates the processing.

On the other hand, in a case where information regarding the system setting is included in the system information (Step S405, Yes), the control unit 150 changes the system setting through the agent 50a (step S406).

Next, effects of the activity trace extraction device 100 according to this example will be described. The activity trace extraction device 100 can selectively extract an activity trace effective for detection and generate an effective IOC by detecting the time dependency and environment dependency of the activity trace.

For example, the activity trace extraction device 100 collects the first analysis log by executing malware in the first environment. The activity trace extraction device 100 collects the second analysis log by executing malware in the second environment after a lapse of a predetermined time period from the first environment. The activity trace extraction device 100 identifies a time-dependent activity trace based on the first analysis log and the second analysis log.

In addition, the activity trace extraction device 100 collects the third analysis log by executing malware in the third environment in which the environment of the system or the device used by the malware in the first environment is changed. The activity trace extraction device 100 identifies an environment-dependent activity trace based on the first analysis log and the third analysis log.

The activity trace extraction device 100 updates the first analysis log by removing the time-dependent activity trace and the environment-dependent activity trace from the first analysis log, and generates an IOC based on the updated first analysis log. Since the IOC generated by the activity trace extraction device 100 is generated on the basis of an activity trace without time dependency and environment dependency, it is possible to detect malware without increasing the number of IOCs.

Note that the activity trace extraction device 100 virtually changes the API of the system and the device allocated to the malware process 50c in the case of the third environment, but the present invention is not limited to this, and the malware process 50c may be operated by changing an actually available API.

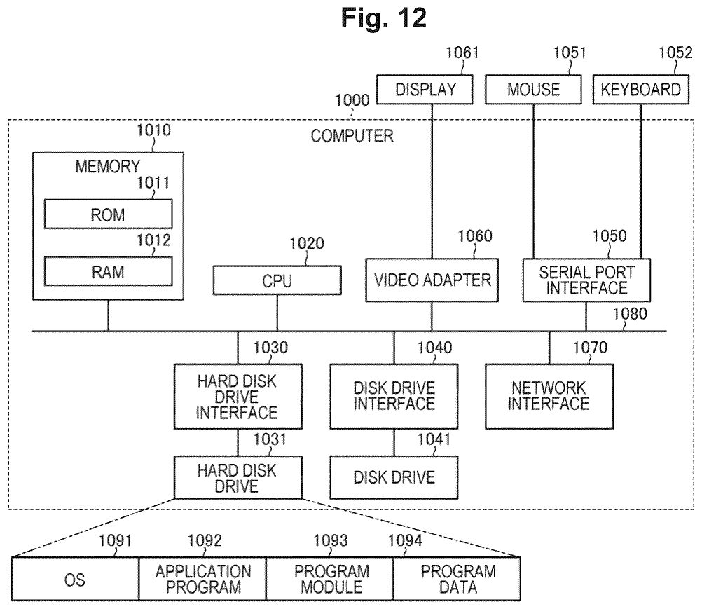

FIG. 12 is a diagram illustrating an example of a computer that executes an activity trace extraction program. A computer 1000 includes, for example, a memory 1010, a CPU 1020, a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1031. The disk drive interface 1040 is connected to a disk drive 1041. A removable storage medium such as a magnetic disk or an optical disk, for example, is inserted into the disk drive 1041. A mouse 1051 and a keyboard 1052, for example, are connected to the serial port interface 1050. A display 1061, for example, is connected to the video adapter 1060.

Here, the hard disk drive 1031 stores, for example, an OS 1091, an application program 1092, a program module 1093, and program data 1094. Each piece of information described in the above embodiment is stored in, for example, the hard disk drive 1031 or the memory 1010.

In addition, the activity trace extraction program is stored in the hard disk drive 1031 as, for example, the program module 1093 in which a command executed by the computer 1000 is described. Specifically, the program module 1093 in which each process executed by the activity trace extraction device 100 described in the above embodiment is described is stored in the hard disk drive 1031.

In addition, data used for information processing by the activity trace extraction program is stored as the program data 1094 in the hard disk drive 1031, for example. The CPU 1020 reads, into the RAM 1012, the program module 1093 and the program data 1094 stored in the hard disk drive 1031 as needed and executes each procedure described above.

Note that the program module 1093 and the program data 1094 related to the activity trace extraction program are not limited to being stored in the hard disk drive 1031, and may be stored in, for example, a removable storage medium and read by the CPU 1020 via the disk drive 1041 or the like. Alternatively, the program module 1093 and the program data 1094 related to the activity trace extraction program may be stored in another computer connected via a network such as a LAN or a wide area network (WAN) and read by the CPU 1020 via the network interface 1070.

Although the embodiment to which the invention made by the present inventor is applied has been described above, the present invention is not limited by the description and the drawings constituting a part of the disclosure of the present invention according to the present embodiment. In other words, other embodiments, examples, operation techniques, and the like made by those skilled in the art and the like on the basis of the present embodiment are all included in the scope of the present invention.

### REFERENCE SIGNS LIST

100 ACTIVITY TRACE EXTRACTION DEVICE
110 COMMUNICATION UNIT
120 INPUT UNIT
130 DISPLAY UNIT
140 STORAGE UNIT
141 TARGET DB
142 HISTORY DB
150 CONTROL UNIT
151 COLLECTION UNIT
152 UPDATE UNIT
153 GENERATION UNIT

1. An activity trace extraction device, comprising:
collection circuitry that is configured to execute malware to collect an analysis log including a plurality of activity traces of the malware, and execute the malware again in an environment indicating time information different from time information at the time of executing the malware to collect a time change analysis log including a plurality of activity traces of the malware;
update circuitry that is configured to update the analysis log by removing, from the analysis log, the activity trace different from the activity trace of the time change analysis log among the plurality of activity traces included in the analysis log based on the analysis log and the time change analysis log; and
generation circuitry that is configured to generate trace information of the malware independent of time lapse based on the updated analysis log.

2. The activity trace extraction device according to claim 1, wherein:
the collection circuitry executes the malware again to further execute a process of collecting an environment change analysis log including a plurality of activity traces of the malware assumed when an execution environment of a system and a device used at the time of executing the malware and information unique to application software are changed, and
the update circuitry updates the analysis log by removing, from the analysis log, the activity trace different from the activity trace of the time change analysis log and the activity trace of the environment change analysis log among the plurality of activity traces included in the analysis log.

3. The activity trace extraction device according to claim 2, wherein:
the collection circuitry further executes a process of acquiring the execution environment of a system and a device used at the time of executing the malware and the information unique to application software, and changing the acquired execution environment.

4. The activity trace extraction device according to claim 1, wherein;
the generation circuitry generates an indicator of compromise (IOC) based on the updated analysis log.

5. An activity trace extraction method, comprising:
executing malware to collect an analysis log including a plurality of activity traces of the malware, and executing the malware again in an environment indicating time information different from time information at the time of executing the malware to collect a time change analysis log including a plurality of activity traces of the malware;
updating the analysis log by removing, from the analysis log, the activity trace different from the activity trace of the time change analysis log among the plurality of activity traces included in the analysis log based on the analysis log and the time change analysis log; and
generating trace information of the malware independent of time lapse based on the updated analysis log.

6. A non-transitory computer readable medium storing an activity trace extraction program for causing a computer to execute:
executing malware to collect an analysis log including a plurality of activity traces of the malware, and executing the malware again in an environment indicating time information different from time information at the time of executing the malware to collect a time change analysis log including a plurality of activity traces of the malware;
updating the analysis log by removing, from the analysis log, the activity trace different from the activity trace of the time change analysis log among the plurality of activity traces included in the analysis log based on the analysis log and the time change analysis log; and
generating trace information of the malware independent of time lapse based on the updated analysis log.
